(19) United States
(12) Patent Application Publication
(10) Pub. No.: US 2010/0012052 A1
(43) Pub. Date: Jan. 21, 2010

(54) METHOD FOR OPERATING A HYBRID DRIVE

(76) Inventors: Ruprecht Anz, Renningen (DE); Michael Werner, Koeln (DE); Oliver Fautz, Ludwigsburg (DE); Michael Glora, Markgroeningen (DE)

Correspondence Address: KENYON & KENYON LLP, ONE BROADWAY, NEW YORK, NY, 10004, US

(21) Appl. No.: 12/305,232

(22) PCT Filed: Aug. 30, 2007
(86) PCT No.: PCT/EP07/59060

§ 371 Date: Jun. 1, 2009

(30) Foreign Application Priority Data
Aug. 30, 2006 (DE) 10 2006 040 638.9

(51) Int. Cl. F02B 61/00

(52) U.S. Cl. 123/2

(57) ABSTRACT

A method for operating a hybrid drive, developed as a parallel hybrid, and having a drive train, especially for a motor vehicle, having at least one internal combustion engine and at least one electrical machine device or a hydraulic machine device, a separating clutch being situated between the internal combustion engine and the electrical or hydraulic machine device and, as seen in the drive direction, the electrical or the hydraulic machine device is postconnected to the internal combustion engine, the separating clutch being separated in the overrun condition if a specifiable drag torque is able to be absorbed by the electrical or the hydraulic machine device.

### FIELD OF THE INVENTION

The present invention relates to a method for operating a hybrid drive, developed as a parallel hybrid drive, and having a drive train, especially for a motor vehicle, having at least one internal combustion engine and at least one electrical or hydraulic machine device, between the internal combustion engine and the electrical or hydraulic machine device a separating clutch being able to be situated and, as seen in the drive direction, the electrical or the hydraulic machine device being postconnected to the internal combustion engine.

### BACKGROUND INFORMATION

At speeds of a motor vehicle greater than zero, if a driver does not operate the accelerator, he normally expects that the vehicle is decelerating, even if he is not operating the brake. In one conventional vehicle, whose drive unit is only an internal combustion engine, the deceleration is determined by a decelerating torque that is created by the nonfunctioning internal combustion engine that is being dragged along. This decelerating torque being created is, among other things, largely a function of the temperature of the internal combustion engine. In particular after a cold start, the decelerating torque is particularly large because of great frictional losses. The decelerating torque is calculated in a control unit, and, as the accelerator touchdown point, is used as the reference point for the driver's command torque for accelerator positions greater than zero.

In a hybrid vehicle having an electric machine or a hydraulic machine this may be used, for instance, for compensating for temperature-caused fluctuations in the decelerating torque.

The electric or the hydraulic machine may also be used to recover kinetic energy and to charge a suitable energy storage unit.

In a hybrid vehicle that has a separating clutch between the internal combustion engine and the electrical machine or the hydraulic machine, the clutch may be separated, so that the internal combustion engine no longer has an influence on the remaining drive train, or rather is no longer operatively connected to it.

### SUMMARY

Example embodiments of the present invention apply to a hybrid vehicle having an internal combustion engine and at least one electric machine. In place of the electric machine, a hydraulic machine may also be used. In that case, a hydraulic or hydrostatic hybrid is involved. A pressure vessel having a more or less compressed gas bladder is then used as the energy storage unit. The description of the method according to example embodiments of the present invention takes place substantially with the aid of an exemplary embodiment having an electric machine, and it applies to an hydraulic or an hydrostatic hybrid by analogy.

The separating clutch, according to example embodiments of the present invention, is separated in the overrun condition, that is, when the internal combustion engine is being dragged along in the nonoperating state, if a specifiable drag torque can be absorbed by the electrical machine device. Thus, in the case in which the electrical machine device is able to completely absorb or produce the specified drag torque, so that the decelerating torque generated by the dragged-along internal combustion engine is not required in order to achieve the specified drag torque, the separating clutch is separated so that the specified drag torque is absorbed only by the electrical machine device. In the overrun condition, the electrical machine device is expediently operated by the generator, whereby, when the clutch is separated, the maximum generator power of the electrical machine device is achieved.

The drag torque able to be absorbed by the electrical machine device is advantageously determined as a function of operating parameters of the electrical machine device. The absorbable drag torque is also limited, of course, by the design and/or dimensioning of the electrical machine device, but the operating parameters of the entire electrical machine device, that keep changing, require special consideration. In that way, damage to the electrical machine device is able to be prevented from the start, the control unit of the vehicle evaluating the operating parameters and correspondingly operating the separating clutch.

The state of at least one electrical storage unit associated with the electrical machine device is expediently used as the operating parameter. In this context, the temperature and the charging potential of the electrical storage unit are preferably observed. Consideration of the temperature of the electrical storage unit prevents overheating, and with that the destruction of the unit that goes along with it. By observing the charge potential, or rather the possible charge potential, it is prevented that the storage unit is charged above and beyond its charge capacity, based on the generator operation. This would also have destructive consequences for the storage unit.

The operating temperature of an electric machine associated with the electrical machine device is advantageously taken into consideration as the operating parameter, so that it is not overheated and destroyed in the process. In addition, the efficiency of the electric machine deteriorates with increasing temperature. This may also be taken into account by the method according to example embodiments of the present invention. The temperature of the internal combustion engine or, in the case of a hydraulic hybrid, the temperature of a component of the hydraulic system, may also be taken into account.

According to example embodiments of the present invention, a setpoint torque is specified for the electrical machine device or the electric machine as a function of the specifiable drag torque, the setpoint torque expediently not exceeding in absolute value the absorbable drag torque. The setpoint torque may, of course, also have a smaller absolute value. In the case where the separating clutch is closed, the specified drag torque is distributed to the internal combustion engine and the electrical machine device, so that the setpoint torque, in this case, is preferably specified as a function of the decelerating torque generated by the internal combustion engine in such a way that the specifiable drag torque is achieved.

In example embodiments of the present invention, the drag torque is specified in a reproducible manner, which means that, independently of the losses caused by the operation in the drive train, that is, for instance, torque losses in the internal combustion engine, the electric machine and/or the transmission, the driver feels a reproducible deceleration of the vehicle.

The drag torque is advantageously specified as a function of the rotational speed of the internal combustion engine. Because of this, a drag torque is able to be specified, for instance, lower in absolute value with increasing engine speed.

The drag torque is advantageously specified as a function of the driving speed. At higher speeds, when the driver takes his foot off the accelerator, he expects a lower deceleration than at low speeds. Consequently, it is of advantage if the drag torque is specified to be lower in absolute value with increasing travel speed.

The drag torque is expediently specified as a function of a selected gear of a transmission of the hybrid drive. The results in the advantages already named above. In low gears, the driver expects a strong decelerating torque if he takes his foot off the accelerator while traveling, whereas the driver rather expects a low decelerating torque while in higher gears.

The drag torque is advantageously taken from a characteristics map and/or from a characteristics curve, the characteristics map and/or characteristics curve being stored in a nonvolatile memory of a drive control unit.

According to example embodiments of the present invention, the setpoint torque is specified as a function of the state of the separating clutch. Thus, the setpoint torque will turn out higher when the separating clutch is open, since in order to achieve the specifiable drag torque alone, the electrical machine device is used, and no torque loss can be used from the internal combustion engine. If the clutch is closed, the setpoint torque turns out correspondingly lower. Thus it is possible to implement the specified drag torque independently of the state of the separating clutch.

The setpoint torque is advantageously specified as a function of at least one auxiliary assembly torque loss in the drive train. If, during travel, air conditioning is switched on for example, the related air conditioner compressor has the effect of a further torque loss in the drive train, which has an effect on the drag torque. For this reason, it is advantageous if the setpoint torque is specified in such a way that the torque loss created is compensated for and the specified drag torque is produced. The setpoint torque is advantageously specified as a function of drive train losses, such as temperature-dependent frictional losses in the bearings of the drive train. The electrical machine device advantageously compensates for these drive train losses, so that, for instance, the driver experiences the same, reproducible decelerating torque, both after a longer trip and after a cold start.

When the separating clutch is separated, the internal combustion engine is advantageously shut down, whereby in addition the fuel consumption of the hybrid drive device is lowered.

In a particularly advantageous manner, the electric machine may be used to recover kinetic energy, independently of whether a serial, parallel or a branched performance system is involved. This applies both for vehicles having an electrical storage device and for vehicles having a hydraulic storage device. Recovery is also possible in a purely electrically driven vehicle, as soon as the driver takes off the gas or accelerator pedal. A setpoint torque decelerating the vehicle is then specified as soon as the driver's command has been recognized. This decelerating torque is used for charging the energy storage device, such as a battery, a supercap or an hydraulic pressure reservoir. If driving comfort is considered important, the torque is only gently increased as soon as the driver releases the accelerator.

If, on the other hand, there is less emphasis on driving comfort, or the recoverable kinetic energy is to be as high as possible, in order to avoid a jolt, only a first small braking torque is specified at first. The braking torque of the electric machine is then increased after some time, up to a maximum value or the standstill of the vehicle. The additional recovered energy obtained thereby is used for charging the energy storage device. This embodiment of the present invention is particularly advantageous to use in driving cycles having frequent start-ups and braking.

Instead of an electric machine, if a hydraulic machine is used for driving or forming a decelerating torque or recovery, and a pressure container is provided as an energy storage device that has a more or less compressed gas bladder, an hydraulic or an hydrostatic hybrid may be formed that has special advantages. Such an hydraulic or hydrostatic hybrid has advantages over an electric hybrid in certain driving cycles.

In the following text, example embodiments of the present invention are described in greater detail with the aid of the drawings.

### BRIEF DESCRIPTION OF THE DRAWINGS

FIG. 1 is a schematic view of exemplary embodiment of the method according to the present invention.

FIG. 2 illustrates a possible curve of the decelerating torque.

### DETAILED DESCRIPTION

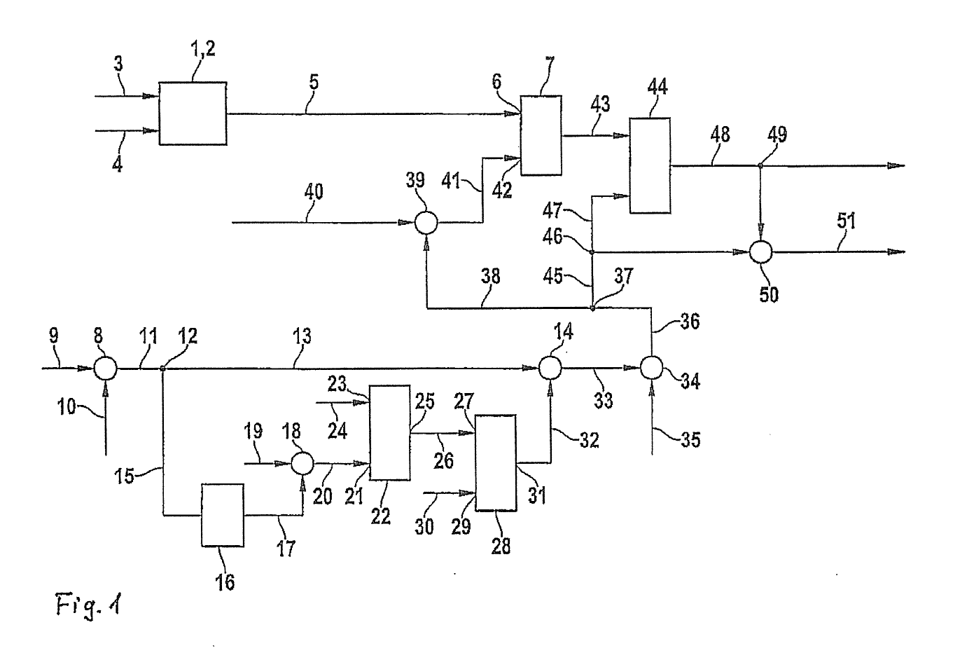

The block diagram in FIG. 1 schematically shows an exemplary embodiment of the method according to the present invention for an electric hybrid. The block diagram shows an element 1 which, for example, represents a control unit 2 of a hybrid drive device, and which calculates a drag torque specification for the hybrid drive device, using at least one stored characteristics map or characteristics curve. A drive train is involved in the hybrid drive device under discussion, having an internal combustion engine and an electrical machine device, the internal combustion engine and the electrical machine device being operatively connected using a separable separating clutch.

The control unit receives a signal, via a connection 3, which reproduces the speed of the vehicle, and it receives a signal via a connection 4, that tells which gear of a transmission of the drive device is engaged. From incoming signals 3 and 4 and the stored characteristics map or characteristics curve, control unit 2 calculates a drag torque, which is indicated via a connection 5.

Instead of the speed and the engaged gear over connections 3 and 4, one could also use a rotational speed of the drive train, such as the rotational speed of the internal combustion engine or of the electric machine, and the transmission ratio of a transmission associated with the drive train. The drag torque determined by control unit 2 is conveyed to a first input 6 of a maximum selector element 7.

Auxiliary assembly torque losses 10 of at least one auxiliary assembly associated with the internal combustion engine are subtracted from a frictional torque 9, of the internal combustion engine, at a subtraction location 8. The decelerating torque measured thereby is led to a branching 12 via a connection 11. A connection 13 leads from branching 12 directly to an input of a multiplication location 14. An additional connection 15 leads from branching 12 to an element 16, in which the absolute amount of the negative decelerating torque coming from subtraction location 8 is determined and is led via a connection 17 to a division location 18, at which a torque 19, transmitted by a separating clutch that is situated between the internal combustion engine and the electric machine, is divided by the decelerating torque that is present at the engine side of the separating clutch.

The result is conveyed via a connection 20 to a first input 21 of a maximum selector 22. At a second input 23 of maximum selector 22, maximum selector 22 receives a comparative value 24 which, in this case, is equal to zero. A connection 26 leads from an output 25 to a first input 27 of a minimum selector 28 which, at a second input 29, receives a comparative value 30 which, in this case, is equal to one. Because of minimum selector 28 and maximum selector 22, the result coming from division location 18 is limited by a value range from zero to one, and is conveyed from an output 31 of minimum selector 28 via a connection 32 to a second input of multiplication location 14, so that the decelerating torque calculated by subtraction location 8 is multiplied by the limited value, the limited value expressing what proportion of the decelerating torque is being transferred by the separating clutch to the drive train. Torque 19 that is transferred by the separating clutch is calculated in a conventional manner.

The value calculated by multiplication location 14 is conveyed via a connection 33 to an input of a second subtraction location 34, at which torque losses 35 stemming from the drive train are subtracted from the result coming from multiplication location 14. The result is led via a connection 36 to a branching 37, the result representing the mechanical overall drag torque as a function of the state of the separating clutch; the mechanical overall drag torque having a value less than zero. A first connection 38 leads from branching 37 to an input of an adding location 39.

At a second input, the minimally possible torque of electric machine 40 is conveyed to adding location 39 and added to the mechanical overall drag torque. The minimally possible torque of electric machine 40 corresponds, in this case, to the largest torque in absolute value of the electric machine in generator operation or the absorbable drag torque of the electrical machine device. It is determined in a conventional manner. It is advantageously determined, in this context, as a function of the temperature of the electric machine, of the electrical storage device associated with the electrical machine device, and/or of the state of charge of the electrical storage device. Since it is a torque that decelerates the vehicle, the fact applies that the minimally possible torque of the electric machine is less than, or equal to zero.

The sum calculated by adding location 39 is led via connection 41 to a second input 42 of maximum selector 7. It limits the drag torque coming from control unit 2 to the minimum torque, that is, the value that is minimally possible. The latter is conducted via a connection 43 to a minimum selector 44, which compares the minimally possible value to the mechanical overall drag torque, which is conveyed from the branching 37 via a connection 45, from a branching 46 and a connection 47 to minimum selector 44. From minimum selector 44 one obtains the actual decelerating torque of the vehicle, and it is led via a connection 48 to a branching 49, where it may be picked off. From branching 49 and branching 46 respectively, a connection leads to a subtraction location 50, at which the mechanical overall drag torque is subtracted from the actual decelerating torque, and the result is output via an output 51.

If the actual decelerating torque is equal to the mechanical overall drag torque, the mechanical losses are greater than the limited minimum drag torque. In this case, there is no possibility of charging an electrical storage unit, such as a battery of the hybrid drive device, without the actual decelerating torque moving even further away from the drag torque specified by control unit 2, for a non-foot-operated accelerator or brake pedal. If the separating clutch is closed, and if it is the case that the maximum recovery torque of the electric machine is greater than, or equal to the decelerating torque of the internal combustion engine which is output via connection 11, then, from the point of view of the drag torque, the condition is satisfied that one should open the separating clutch, since the specified drag torque is able to be absorbed only by the electric machine. The overall drag torque coming from the drive train will then become correspondingly greater, smaller in absolute quantity, since the torque losses of the internal combustion engine and the auxiliary assemblies associated with it cease to apply. From the difference calculated by subtraction location 50, one obtains the setpoint torque at which the electric machine has to be driven in order to achieve the specified drag torque.

Thus, the method advantageously allows one to open the separating clutch in overrun condition as a function of a specified drag torque and of the operating state of the hybrid drive device, when the drag torque is able to be produced or absorbed by the electric machine alone, and consequently, a maximum recovery torque is able to be used advantageously for charging an electrical storage device. If the separating clutch is separated, or rather opened, the internal combustion engine is advantageously shut down, so that fuel is saved, in addition.

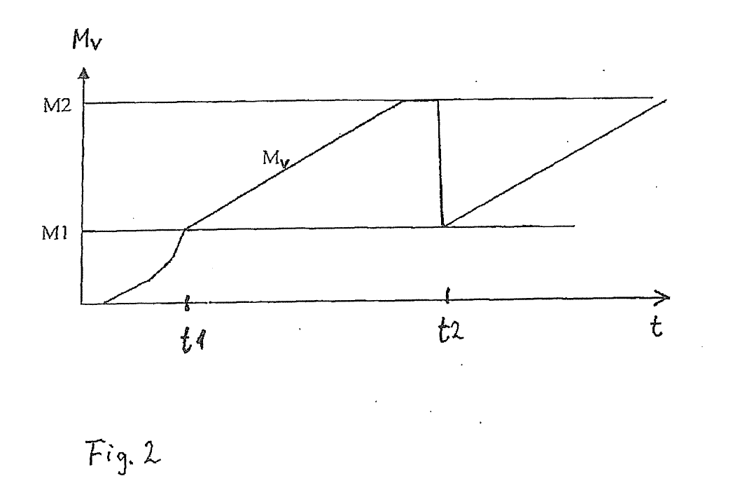

If there is less emphasis on driving comfort, or the recoverable kinetic energy is to be as high as possible, in one embodiment of the present invention, in order to avoid a jolt, only a small braking torque M1 is specified at first. The braking torque of the electric machine is then increased after a change in time of M1, up to a maximum value M2 or the standstill of the vehicle. FIG. 2 shows, for example, a variation in time of the absolute amount of the decelerating torque. In this instance, at time t1 the driver releases the gas pedal, and at point t2 the driver ends his deceleration command by gently tapping the gas pedal.

The additional recovered energy created is used for charging the energy storage device. This example embodiment of the present invention is particularly advantageously usable in driving cycles having frequent drive-aways and braking, such as in garbage trucks, city buses or generally in city traffic.

The manner in which decelerating torque M1 is able to be specified as a function of speed, drive train transmission ratio or the state of clutches in the drive train, was described above. A setpoint torque M2 may be specified in the same way, it being ensured that the decelerating torque M2≧M1, by data input for the parameters required for this.

Decelerating torque Mv is calculated from interpolation between M1 and M2. This is done, for example, according to the equation

Mv=M1+x(t)(M2−M1)+M1

where t is the time and it is true that
x(t=O)=0 and x(t), for t tending to infinity, is ≦1.

In addition to being time-dependent, interpolation factor x may also be a function of additional physical variables, such as speed, drive train transmission ratio, etc.

The design approaches and methods described above for a hybrid having an electric machine and an electrical energy storage device may also be implemented for a hydraulic hybrid having a hydraulic machine for the drive and a pressure container as the energy storage device. It is also possible to have a hybrid vehicle having a combination of an internal combustion engine, an electric machine and a hydraulic machine.

1-22. (canceled)

23. A method for operating a hybrid drive, arranged as a parallel hybrid, and having a drive train having at least one internal combustion engine and a machine device arranged as at least one of (a) at least one electrical machine device and (b) at least one hydraulic machine device, a separating clutch being arranged between the internal combustion engine and the machine device, as seen in a drive direction, the machine device postconnected to the internal combustion engine, comprising:
separating the separating clutch in an overrun condition if a specifiable drag torque is absorbable by the machine device.

24. The method according to claim 23, wherein the hybrid drive is arranged as a hybrid drive for a motor vehicle.

25. The method according to claim 23, wherein the drag torque that is able to be absorbed by the machine device is determined as a function of operating parameters of the machine device.

26. The method according to claim 25, wherein a state of at least one electrical storage device associated with the electrical machine device is used as the operating parameter.

27. The method according to claim 25, wherein a state of at least one hydraulic storage device associated with the hydraulic machine device is used as the operating parameter.

28. The method according to claim 25, wherein at least one of (a) an operating temperature of an electric machine associated with the electrical machine device and (b) a temperature of the internal combustion engine is used as the operating parameter.

29. The method according to claim 25, wherein at least one of (a) an operating temperature of an hydraulic component associated with the hydraulic machine device and (b) a temperature of the internal combustion engine is used as the operating parameter.

30. The method according to claim 23, wherein a setpoint torque is specified to the electrical machine device as a function of the specifiable drag torque.

31. The method according to claim 23, wherein the specifiable drag torque is specified in a reproducible manner.

32. The method according to claim 23, wherein the specifiable drag torque is specified as a function of a rotational speed of the internal combustion engine.

33. The method according to claim 23, wherein the specifiable drag torque is specified as a function of a driving speed.

34. The method according to claim 23, wherein the specifiable drag torque is specified as a function of a selected gear of a transmission of the hybrid drive.

35. The method according to claim 23, wherein a setpoint torque is specified such that an absorbable drag torque is not exceeded.

36. The method according to claim 23, wherein the specifiable drag torque is taken from at least one of (a) a characteristics map and (b) a characteristics curve.

37. The method according to claim 23, wherein a setpoint torque is specified as a function of a state of the separating clutch.

38. The method according to claim 23, wherein a setpoint torque is specified as a function of at least one auxiliary assembly torque loss.

39. The method according to claim 23 wherein the internal combustion engine is shut down when the separating clutch is separated.

40. The method according to claim 23, wherein a setpoint torque decelerating a vehicle is settable to values that are greater in absolute value than a decelerating setpoint torque and that are variable in time.

41. The method according to claim 40, wherein a transition from the decelerating setpoint torque to a maximum value of the absolute value of the decelerating setpoint torque takes place at least one of (a) continuously over time and (b) according to an interpolation formula.

42. The method according to claim 41, wherein the interpolation formula reads:
Mv=M1+x(t)(M2−M1)+M1;
t is the time and it is true that;
x(t=O)=0 and x(t) for t tending to infinity is ≦1;
M1 representing the decelerating setpoint torque; and
M2 representing the maximum value of the absolute value of the decelerating setpoint torque.

43. The method according to claim 42, wherein in addition to being time-dependent, the interpolation factor x(t) is also a function of additional physical variables.

44. The method according to claim 43, wherein the additional physical variables include at least one of (a) a speed and (b) a drive train transmission ratio.
